(19) United States
(12) Patent Application Publication
(10) Pub. No.: US 2024/0124997 A1
(43) Pub. Date: Apr. 18, 2024

(54) METHOD FOR REMOVING ELEMENTAL PHOSPHORUS FROM IRON OXIDE-CONTAINING AND PHOSPHATE-CONTAINING SUBSTANCES

(71) Applicant: RADMAT AG, Fislisbach (CH)

(72) Inventor: Alfred EDLINGER, Bartholomäberg (AT)

(73) Assignee: RADMAT AG, Fislisbach (CH)

(21) Appl. No.: 18/287,042

(22) PCT Filed: Apr. 7, 2022
(86) PCT No.: PCT/IB2022/053262

§ 371 Date: Oct. 16, 2023

(30) Foreign Application Priority Data
Apr. 14, 2021 (AT) A 60112/2021
May 17, 2021 (AT) A60145/2021
Jun. 17, 2021 (AT) A 113/2021

(51) Int. Cl. C25B 15/08; C25B 1/01; C25B 9/63; C25B 11/046

(52) U.S. Cl. CPC C25B 15/08; C25B 1/01; C25B 9/63; C25B 11/046

(57) ABSTRACT

A method for separating elemental phosphorus from iron oxide-containing and phosphate-containing materials includes at least the following steps: providing at least one iron oxide-containing and phosphate-containing material, adding at least one aluminum carrier to the at least one iron oxide-containing and phosphate-containing material and melting the at least one aluminum carrier together with the at least one iron oxide-containing and phosphate-containing material to form an aluminum-containing and optionally aluminum oxide-containing phosphate slag melt, reacting the aluminum-containing and optionally aluminum oxide-containing phosphate slag melt to elemental, gaseous phosphorus, iron and Al₂O₃-containing slag in a melting vessel, withdrawing the elemental, gaseous phosphorus and tapping off the iron and the Al₂O₃-containing slag.

### CROSS-REFERENCE TO RELATED APPLICATIONS

The present application is a national phase application of PCT Application No. PCT/IB2022/053262, filed Apr. 7, 2022, entitled “METHOD FOR REMOVING ELEMENTAL PHOSPHORUS FROM IRON OXIDE-CONTAINING AND PHOSPHATE-CONTAINING SUBSTANCES”, which claims the benefit of Austrian Patent Application Nos. A 60112/2021, filed Apr. 14, 2021, A60145/2021, filed May 17, 2021, and A 113/2021, filed Jun. 17, 2021 each of which is incorporated by reference in its entirety.

### BACKGROUND OF THE INVENTION

### 1. Field of the Invention

The present invention relates to a method for separating elemental phosphorus from iron oxide-containing and phosphate-containing materials, in particular from waste materials such as sewage sludge (ash), animal meal, bone meal and/or steelworks slag, preferably together with materials such as apatite, phosphate ores and/or phosphorite, and to an apparatus for carrying out the method according to the invention.

### 2. Description of the Related Art

Prices for rock phosphate have recently been experiencing a steady increase due to the shortage of suitable raw material sources. In addition, the exploited phosphate ores increasingly contain significant levels of uranium, cadmium, selenium, and other harmful by-products. Such accompanying elements can only be removed at great expense, so that the use of phosphates from such contaminated ores is becoming increasingly uneconomical.

On the other hand, waste materials sometimes contain relatively high levels of phosphorus compounds. This applies, for example, to sewage sludge, animal meal, bone meal and/or steel mill slag and the like.

High-purity phosphorus starting materials, which can be prepared from elemental phosphorus (P₄, white phosphorus), are required in particular for food production and for the pharmaceutical industry. However, production is becoming increasingly difficult and is currently no longer carried out, at least in Europe.

A major problem in the recovery of elemental phosphorus from the starting materials of the type mentioned above, in particular from waste materials such as sewage sludge, animal meal, bone meal and/or steelworks slag and/or from materials such as apatite, phosphate ores and/or phosphorite, lies in the formation of phosphorus sludge, which is formed, for example, during the Wohler process from silicate- and carbon-containing accompanying substances of the iron oxide-containing and phosphate-containing materials with the inclusion of various phosphorus species. Phosphorus sludge is highly toxic and poses an immense problem, as its disposal makes the extraction of elemental phosphorus using previously known processes more or less hopeless from an economic point of view. Furthermore, in conventional processes for the recovery of elemental phosphorus, the formation of phosphines (in particular PH₃, in the context of the present invention also generally PHₓ), which are volatile and highly toxic as an odorless gas, is a major problem.

### SUMMARY OF THE INVENTION

The present invention is therefore based on the task of creating a process as well as a corresponding apparatus which enable the recovery of elemental phosphorus from the aforementioned starting materials without the formation of phosphorus sludge or phosphines. At the same time, the formation of undesirable iron-phosphorus alloys such as iron phosphides, ferrophos and Fe₂P as well as CO₂ emissions are to be avoided compared to prior art processes.

To solve this task, the method according to the invention comprises at least the following steps:
providing at least one iron oxide- and phosphate-containing material
adding at least one aluminum carrier to the at least one iron oxide- and phosphate-containing material and melting the at least one aluminum carrier together with the at least one iron oxide- and phosphate-containing material to form an aluminum-containing and optionally aluminum oxide-containing phosphate slag melt,
reacting the aluminum-containing and optionally alumina-containing phosphate slag melt to elemental gaseous phosphorus, iron and an Al₂O₃-containing slag in a melting vessel, extracting elemental gaseous phosphorus and tapping off iron and Al₂O₃-containing slag.

In the process according to the invention, the starting materials are melted together with at least one aluminum carrier. In the resulting melt, which is an aluminum-containing phosphate slag melt and may possibly already contain aluminum oxide initially, there is subsequently an exothermic release of elemental phosphorus (P₂, gaseous) and of metallic iron. The method according to the invention thus utilizes an autothermal redox reaction between the redox partners iron oxide, phosphorus oxide (phosphate) and aluminum, which are present in different reduction stages, whereby the redox reaction is strongly exothermic and the reaction is thus maintained by itself.

In the melt phase, the phosphate slag forms easily movable, electrically conductive cation and anion clusters (ion complexes). For example, cation clusters are formed from Fe²⁺, Ca²⁺, Mg²⁺, Na⁺, K⁺ and the like, and anion clusters are formed from, for example, PO₄³⁻, SiO₃⁻, SiO₄⁴⁻, SiO₃²⁻ and AlO₃³⁻. A deliberate electrothermal (melt flow electrolysis) and/or aluthermic partial reduction of the phosphorus oxides of the phosphate slag melt leads to an extremely rapid reduction of the phosphates to gaseous P₂ and of the iron oxides to metallic iron. Due to the exothermic nature of the process according to the invention, large amounts of heat are released, so that the reaction is maintained by itself and may have to be cooled.

In an advantageous manner, it may be provided that aluminum dross is used as the aluminum carrier. Dross is produced during the electrolysis of alumina for the production of metallic aluminum or during the melting of scrap aluminum. The dross consists of metallic aluminum, but which is surrounded by an aluminum oxide skin. The dross forms due to the oxidation of aluminum to alumina on the surface of the corresponding electrolysis or smelting tanks and is difficult to dispose of. For example, attempts are made to break down the oxidic skin by the use of fluorides, but this obviously leads to serious further waste and exhaust problems from these processes. The use of dross in the method according to the invention now has the advantage that, in addition to the aluminum desired for the reduction, alumina, i.e. the reaction product of the process according to the invention, is also added so that the strongly exothermic reaction is moderated and the exotherm is thus reduced. At the same time, a slag with a particularly high alumina content is obtained, which ensures outstanding early strength values for cements containing this slag.

The conversion takes place so suddenly that any intermediates of phosphorus and compounds of phosphate and phosphorus with accompanying substances of the starting materials cannot be formed and thus the formation of phosphorus sludge and phosphines is prevented and effectively avoided. Aluminates and non-metallic accompanying substances accumulate in the slag, while heavy metals possibly contained, for example, in sewage sludge or steel mill slag or mill scale are alloying in the iron formed. In this way, pure phosphorus is obtained directly in the gas phase, and the P₂ initially formed can be converted to further phosphorus modifications such as P₄ by cooling methods known per se, such as cooling and quenching with water, or by indirect cooling with preferably regenerative heat exchangers.

After shock cooling, the slag formed can be used in the cement industry as a high-quality hydraulic binder, for which additional aggregates can be added to the slag, if necessary, depending on the requirements for the target analysis of the slag. For example, by increasing the addition of metallic aluminum, the SiO₂ content of the target slag can also be reduced while simultaneously increasing the aluminum content. In this case, an FeSi-containing molten iron with somewhat increased aluminum content is produced. This iron alloy can be advantageously used in steel metallurgy as a deox alloy addition.

With regard to the mixing of the starting materials and the aluminum carrier, according to a preferred embodiment of the present invention, the at least one iron oxide- and phosphate-containing material can be provided as a phosphate slag melt in the melting vessel and the at least one aluminum carrier is added to the phosphate slag melt. In this case, the phosphate slag melt can be provided from an oxidative process already largely free of pollutants, so that the formation of undesirable, toxic substances is avoided from the outset.

According to a preferred alternative embodiment of the present invention with respect to the mixing of the starting materials as well as the aluminum carrier, it may also be provided that a solid material, in particular sewage sludge ash with a lime carrier and/or apatite and/or phosphate ore, is provided as the iron oxide- and phosphate-containing material and that solid metallic aluminum is added as the at least one aluminum carrier. In this case, the aluminum carrier is thus not added to an already existing phosphate slag melt, but the starting material is brought into contact in solid form with a solid aluminum carrier, the metallic aluminum, during addition. Here, the substances are preferably ground into fine powders to provide a large reaction surface. The mixture obtained by the step of adding must initially be ignited in some way. This can be accomplished with a spark plug or a flame, or it can be accomplished by phosphate slag melting already present in the melting vessel. As the reaction proceeds, it maintains itself due to the exothermic nature of the redox reaction.

As already mentioned several times, the redox reaction between iron oxide, phosphorus oxide and aluminum is highly exothermic and therefore large amounts of heat are generated in the method according to the invention, most of which require the reaction to be cooled. In addition to the obvious possibilities of cooling the melting vessel or the phosphate slag melt by means of various cooling coils, heat exchangers and the like, according to a preferred embodiment of the present invention it is also possible to proceed for this purpose in such a way that an Al₂O₃ carrier is added to the aluminum-containing and optionally alumina-containing phosphate slag melt. Al₂O₃ (aluminum oxide) is also a product of the redox reaction of the method according to the invention. The addition of the, preferably cold, alumina carrier shifts the equilibrium of the redox reaction towards the starting materials and thus inhibits the reaction rate and also the release of heat. In this way, overheating of the phosphate slag melt or the melting vessel at the point of heat release can be effectively avoided without introducing unreactive chemical species into the process. In this context, it is particularly advantageous that the increased Al₂O₃ content of the target slag due to the addition of Al₂O₃ makes it suitable for the production of fast-binding cement.

For optimized process control, it is expedient, especially with regard to a desirable viscosity of the melt, that the basicity (CaO/SiO₂) of the aluminum-containing and optionally alumina-containing phosphate slag melt is adjusted to a value of 0.65 to 1.4, preferably 0.85 to 1.2 and particularly preferably 1, preferably by adding CaO carriers and/or SiO₂ carriers, as corresponds to a preferred embodiment of the present invention. In particular, the chemical analysis of the target slag shows the following proportions of the main components (in wt %):

| | |
|---|---|
| CaO | 22-56 |
| Al₂O₃ | 32-55 |
| SiO₂ | 1-22 |
| Fe₂O₃ | 0.15-3 |
| MgO | 2-15 |
| P | 0.05-1.2 |

This corresponds to the directional analysis of a high-quality alumina fused cement.

Preferably, a tin bath is provided as a cathode body in the melting vessel under the aluminum-containing and optionally alumina-containing phosphate slag melt, and at least one anode body, preferably made of graphite, platinum or magnetite spinel, is provided to be immersed in the aluminum-containing and optionally alumina-containing phosphate slag melt. This enables the electrochemical influence of the process according to the invention, as will be explained below. The choice of material for the anode body can be made according to various aspects. While graphite electrodes are undoubtedly inexpensive to purchase, in the process of the invention, however, they are degraded relatively rapidly by nascent oxygen to form carbon dioxide. However, the formation of carbon dioxide is to be avoided for climate protection reasons and frequent anode replacement is undesirable from an economic point of view. It was observed that anodes made of platinum or magnetite, and especially magnetite spinel, are expensive, especially in the case of platinum, but have an extremely long service life. Another advantage is that only oxygen and no carbon dioxide is produced at such electrodes.

In order to minimize the use of metallic aluminum as much as possible, it may be provided that a direct current, preferably a direct current of 3 V to 15 V, preferably of 6 V to 12 V, more preferably of 8 V to 10 V, is applied to the cathode body and the anode body, as corresponds to a preferred embodiment of the present invention. This allows the reactions to be driven beyond the natural chemical equilibrium by electrolysis. The iron formed accumulates in the tin bath and undercoats the tin bath when the tin bath reaches saturation.

Alternatively, however, if the reaction is more or less complete due to the quality of the starting materials and optimum adjustment of the basicity of the phosphate slag melt and the temperature, it is also preferable for a direct current to be drawn from the cathode body and the anode body. In this case, the process according to the invention provides electrical energy by forming an electrical voltage between the anode and the cathode, which can trigger an external current flow that can be used in any conceivable way. At the same time, this galvanic chain can also be used to measure the reaction progress in the phosphate slag melt. When iron oxide and phosphorus oxide of the phosphate slag melt are completely reduced and are present in the elemental form, no current flows. Accordingly, experiments have shown that the current flow decreases as a function of the progress of phosphate slag reduction. Further added aluminum (metallic aluminum) no longer reacts with the now reduced phosphate slag melt.

In order to be able to separately obtain the products of the cathode reaction and the anode reaction, it is provided according to a preferred embodiment of the present invention that the cathode body is provided in a first region of the melting vessel in a depression arranged in a partial region of the bottom in the melting vessel and that the at least one anode body is provided in a second region of the melting vessel different from the first region, and that gaseous phosphorus is withdrawn from the first region and oxygen from the second region. By arranging the cathode body in an area which is different from the area in which the anode body is arranged, the products of the cathode and the anode reaction occur in the melting vessel or in the gas space of the melting vessel in separate locations and can thus also be withdrawn separately. At the cathode, these are iron and gaseous phosphorus, and at the anode, in the case of an inert anode, only oxygen is produced in gaseous form. The iron formed accumulates in the tin bath, undercoats the tin bath when the tin bath reaches saturation, and can be withdrawn from the depression.

The device according to the invention for carrying out the method according to the invention comprises a melting vessel formed by a refractory-lined housing, a phosphate slag melt containing aluminum and optionally aluminum oxide arranged in the melting vessel, a gas chamber closed off by the housing above the phosphate slag melt, as well as a feed device for substances containing iron oxide and phosphate and at least one discharge device for gaseous elemental phosphorus.

In this device according to the invention, the aluminum carriers can be melted together with the iron oxide-containing and phosphate-containing materials, the starting materials. In the resulting melt, which is a phosphate slag melt containing aluminum and possibly alumina, there is an exothermic release of elemental phosphorus (P₂, gaseous) and metallic iron corresponding to the addition rate of the metallic aluminum. After reduction or conversion, the original phosphate slag melt is practically free of phosphorus and iron.

If, as previously described in connection with a preferred embodiment of the method according to the invention, the at least one iron oxide- and phosphate-containing material is provided as a phosphate slag melt in the melting vessel and the at least one aluminum carrier is added to the phosphate slag melt, the apparatus according to the invention is preferably characterized in that the feed device has a first tube which passes through the housing and in which a conveying device, preferably in the form of a screw conveyor, for at least one aluminum carrier is arranged. Through this first tube, the aluminum carriers can be introduced into the housing of the device and ultimately into the phosphate slag melt, where they are melted together with the phosphate slag melt. The reduction process of the phosphate slag melt corresponds to the addition rate of the metallic aluminum.

According to a previously described alternative variant of the present invention, it is provided that a solid material, in particular sewage sludge ash with a lime carrier and/or apatite and/or phosphate ore, is provided as the iron oxide- and phosphate-containing material, and that solid metallic aluminum is added as the aluminum carrier. At this point, the addition of aluminum scrap, preferably magnesium-alloyed, phosphate-containing steel slag, phosphate-containing mill scale and the like as solids would also be conceivable. In this case, the device according to the invention is preferably characterized in that the feed device comprises a first tube passing through the housing, in which first tube a second tube is arranged forming an annular gap, preferably concentric to the first tube, wherein one of the first and the second tube is designed for feeding materials containing iron oxide and phosphate and the other of the first and second tube is designed for feeding aluminum carriers, and wherein the first tube projects beyond the second tube at its end passing through the housing. This feed device allows two solid components, namely the iron oxide-containing and phosphate-containing material or the starting material and the aluminum carrier, to be fed together to the device, whereby, due to the fact that the first tube projects beyond the second tube at its end passing through the housing, contact is established between the two components in the feed device, which leads to the formation of an autothermally maintained reaction front at which the aluminum carrier is melted together with the iron oxide-containing and phosphate-containing substances and at which the exothermic reduction reaction begins. The resulting aluminum-containing and, if necessary, alumina-containing phosphate slag melt then passes into the interior of the melting vessel and into the existing phosphate slag melt, where complete conversion to iron and elemental phosphorus takes place. Both the first and second tubes may include suitable conveying means to convey the components. In the region of the end of the second tube, an ignition device may be provided for the aluminum carrier and the iron oxide-containing and phosphate-containing material, but ignition of the mixture of the two aforementioned components may also be provided by the heat of the phosphate slag melt.

In order to electrochemically influence the method according to the invention, the device according to the invention is preferably further designed in that the device has a cathode body arranged under the aluminum-containing and optionally alumina-containing phosphate slag melt and at least one anode body immersed in the aluminum-containing and optionally alumina-containing phosphate slag melt. The cathode body and the anode body are provided in a known manner with electrical leads to form a circuit.

In order to be able to obtain the products of the cathode reaction and the anode reaction separately, it is provided, according to a preferred embodiment of the present invention, that the cathode body is arranged in a first region of the melting vessel in a depression arranged in the bottom of the melting vessel, and that the at least one anode body is arranged in a second region of the melting vessel laterally spaced from the first region, and a further draw-off device is arranged in the second region. By arranging the cathode body in an area which is different from the area in which the anode body is arranged, the products of the cathode and the anode reaction occur in the melting vessel or in the gas space of the melting vessel in separate locations and can thus also be withdrawn separately. At the cathode, these are iron and gaseous phosphorus, and at the anode, in the case of an inert anode, only oxygen is produced in gaseous form. The iron formed accumulates in the tin bath, undercoats the tin bath when the tin bath reaches saturation, and can be withdrawn from the depression.

In order to achieve the most complete possible separation of the products of the cathode reaction and the anode reaction in the gas space of the apparatus according to the invention, the invention is preferably further designed in that a separating wall dividing the gas space into two sections separated from one another is immersed in the aluminum-containing and optionally alumina-containing phosphate slag melt between the first section and the second section. Thus, products of the cathode reaction cannot enter the first region with the anode and vice versa and can be withdrawn separately in this way.

On the other hand, when the gaseous products of the cathode reaction and the anode reaction are combined in an exothermic reaction, exceedingly pure P₂O₅ is formed. The P₂O₅ formed in this reaction is so pure that it can be converted directly into food-grade phosphoric acid by hydrolysis and used accordingly.

According to a preferred embodiment of the present invention, the cathode body is formed by a tin bath. A tin bath as cathode has the advantage that, in addition to the iron formed in the device according to the invention during the process according to the invention, heavy metals, which under certain circumstances may be contained, for example, in sewage sludge, steel mill slag or mill scale, alloy in the iron formed and are thus bound. As soon as the tin bath is saturated with iron, the iron formed in the method according to the invention undercoats the tin bath and can be drawn off.

To increase the service life of the device according to the invention, the tin bath is accommodated in a carbon-containing body arranged in the depression, as corresponds to a preferred embodiment of the present invention. The carbon-containing body can preferably be formed as a graphite body, or consist of a carbon-containing mass.

According to a preferred embodiment of the present invention, the anode body may be formed of graphite, platinum or magnetite spinel. Graphite electrodes are widely used in the prior art and, when the method according to the invention is carried out in the device according to the invention, lead to the formation of CO and optionally CO₂ at the anode. The CO (carbon monoxide) can subsequently be thermally recycled. The graphite anode is consumed in the process and must be renewed regularly. The advantages of the other anode materials described have already been explained above in connection with the method according to the invention.

According to an alternative embodiment, in order to permit a CO-free process, the invention may be further embodied in that the at least one anode body is formed from a high alloy steel, the steel preferably being platinum coated. A platinum coating increases the inherently good service life of a high-alloy steel anode and also provides catalytic properties.

Furthermore, the use of a Söderberg electrode as anode body is also conceivable.

As mentioned above, when the method according to the invention is carried out, large amounts of heat are released in the device according to the invention, which can sometimes affect the apparatus. To prevent this, the at least one anode body can be designed to be cooled, preferably by channels arranged inside the anode body for a tin melt, a salt melt or sodium melt or for gas cooling, preferably by nitrogen or argon, as corresponds to a preferred embodiment of the present invention.

As previously described, in order to minimize the use of aluminum as much as possible, it may be provided that a direct current, preferably a direct current of from 3 V to 15 V, preferably from 6 V to 12 V, more preferably from 8 V to 10 V, is applied to the cathode body and the anode body. This allows the reactions to be driven beyond the natural chemical equilibrium by electrolysis. To this end, according to a preferred embodiment of the present invention, the device has means for applying a direct current to the cathode body and the anode body.

Alternatively, however, if the reaction is more or less complete due to the quality of the starting materials and optimum adjustment of the basicity of the phosphate slag melt and the temperature, it is also preferable for a direct current to be drawn from the cathode body and the anode body. In this case, the method according to the invention provides electrical energy that can be used in any conceivable way. To this end, the device has means for taking a direct current from the cathode body and from the anode body, in accordance with a preferred embodiment of the present invention. The anode reaction can be specified as follows:

Al->Al³⁺+3e⁻

This represents an electron release and consequently an oxidation of metallic aluminum.

The cathode reactions can be specified here as follows:

P³⁺+3e⁻->P

Fe³⁺+3e⁻->Fe

This represents an electron uptake and thus a reduction of the iron oxides and phosphorus oxides.

### BRIEF DESCRIPTION OF THE DRAWINGS

The invention is explained in more detail below with reference to an example of an embodiment shown in the drawing. Therein,

FIG. 1 shows a schematic representation of a first device according to the invention,

FIG. 2 shows a representation of a device according to the invention with a cathode body and several anode bodies,

FIG. 3 shows a feed device according to a first embodiment of the device according to the invention, preferably for the device according to FIG. 1, and

FIG. 4 shows an embodiment of the present invention in which a direct current can be taken at the electrodes.

### DETAILED DESCRIPTION

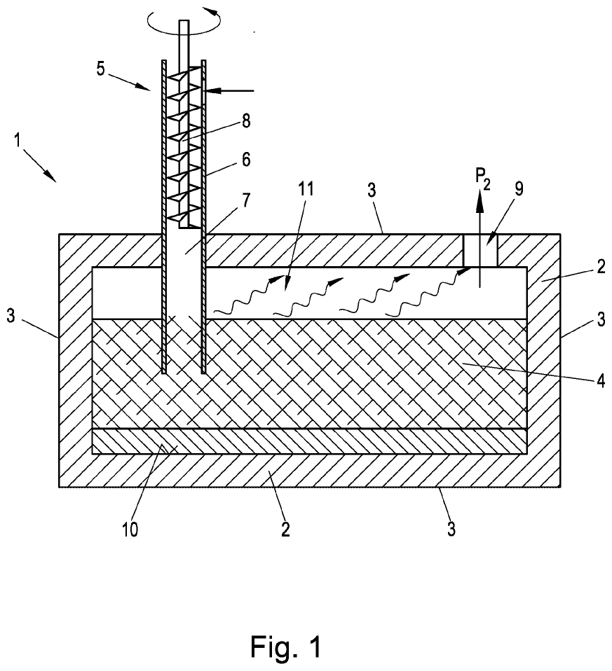

In FIG. 1, the device according to the invention is indicated by the reference numeral 1. The device 1 comprises a housing 3 made of mild steel sheet and fed with a refractory material 2 to form a melting vessel 11. A refractory material suitable for the present invention was found to be magnesium spinel in an Al₂O₃ matrix, which material is known as sintered refractory concrete. Corundum bricks are also suitable as refractory material. Phosphate slag melt 4 is arranged in the housing as the iron oxide-containing and phosphate-containing materials. A feed device 5 of the device 1 passes through the housing 3 with a first tube 6. Aluminum carriers 7 or Al₂O₃ carriers containing metallic aluminum can be fed through the first tube 6 of the feed device 5, which is accomplished by a conveying device 8 in the form of a screw conveyor. The feed device 5 is immersed in the phosphate slag melt 4, whereby the aluminum carriers 7 directly reach the depth of the phosphate slag melt, where they are melted together with the iron oxide- and phosphate-containing materials, namely the phosphate slag melt 4, and rapidly converted to elemental phosphorus and iron. The phosphorus is drawn off via the draw-off device 9 and the iron collects at the bottom 10 of the melting vessel 11. There the iron can be tapped. The phosphate slag melt 4 converts to phosphate-free cement slag without the addition of further starting materials.

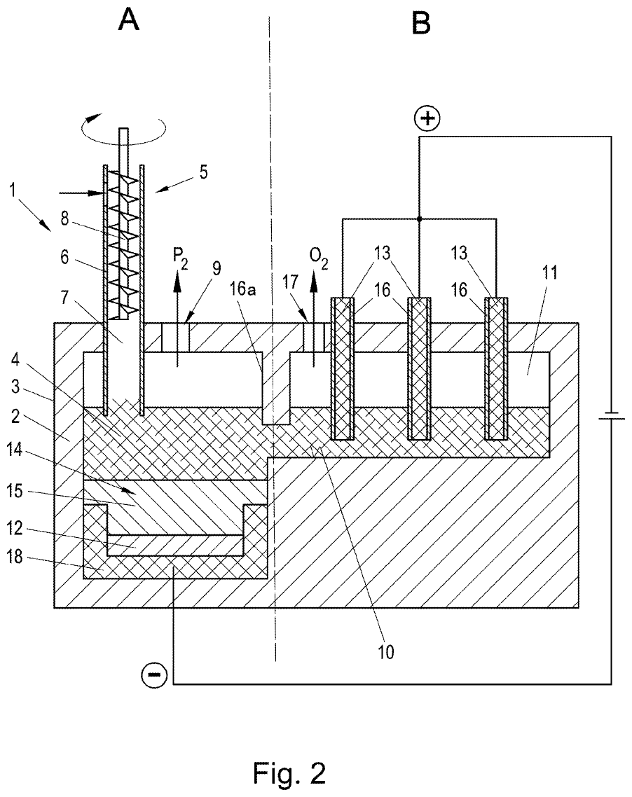

In FIG. 2, the same parts are marked with the same reference numerals. The device 1 according to FIG. 2 has a cathode body 15 arranged under the aluminum-containing phosphate slag melt 4 and a plurality of anode bodies 13 immersed in the aluminum-containing phosphate slag melt 4, the cathode body 15 being formed by a tin bath. In this case, the tin bath is arranged in a depression 14 in the bottom 10 of the melting vessel 11 and is undercoated by the iron formed as the reaction progresses. The tin bath is contained in a graphite body 18 located in the depression. An iron layer forming under the cathode body 15 is designated by the reference numeral 12. The current is then introduced through the graphite body 18, the iron layer 12 and the tin bath 15. The anode bodies 13 may be formed of graphite or high-alloy steels and may be provided with a coating 16.

The cathode body 15 is disposed in a first region A of the melting vessel 11, the first region A being separated from a second region B laterally spaced from the region A by a separating wall 16a which is immersed in the phosphate slag melt 4. Elemental phosphorus in the form of P₂ is extracted at the extraction device 9, and oxygen (O₂) escapes at a further extraction device 17 associated with the second area B in the case of coated anode bodies. A direct current is applied to the cathode and the anode in a known manner.

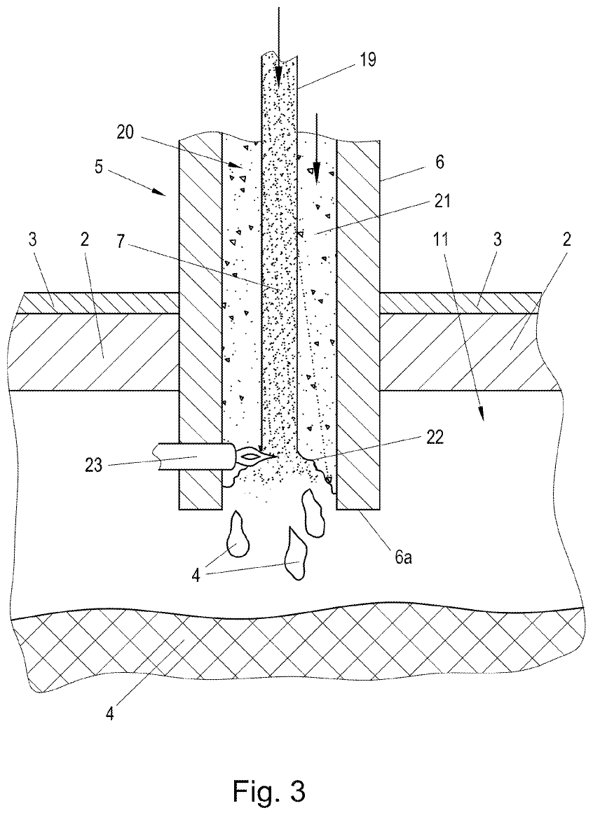

The feed device 5 according to FIG. 3 has a first tube 6 penetrating the housing 3, in which first tube 6 a second tube 19 is arranged concentrically to the first tube 6, forming an annular gap 20. The first tube 6 projects beyond the second tube 19 at its end 6a which passes through the housing 3. Two solid components, namely the iron oxide- and phosphate-containing material 21 and the starting material 21, respectively, and an aluminum carrier 7, in this case metallic aluminum, which are fed together to the device, come into contact with one another, which leads to the formation of an autothermally maintained reaction front 22 at which the aluminum carrier 7 is melted together with the iron oxide- and phosphate-containing material 21. The resulting phosphate slag melt 4 containing aluminum and aluminum oxide is symbolized by droplets and hereupon enters the interior of the melting vessel and the already existing phosphate slag melt, where the complete conversion to iron and elemental phosphorus takes place. In the region of the end 6a of the second tube 6, an ignition device 23 may be provided for the aluminum carrier 7 and the iron oxide- and phosphate-containing substance 21.

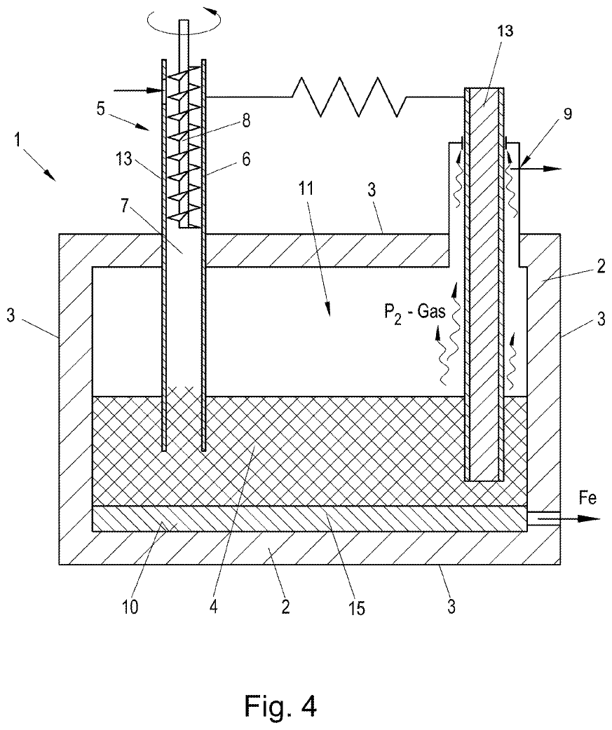

In the embodiment shown in FIG. 4, the anode body 13 is arranged around the first tube 6 of the feed device 5 and means are provided for taking a direct current from the cathode body 15 and the anode body 13.

1-22. (canceled)

23. A method for separating elemental phosphorus from iron oxide-containing and phosphate-containing material, comprising:
providing at least one iron oxide- and phosphate-containing material;
adding at least one aluminum carrier to the at least one iron oxide- and phosphate-containing material and melting the at least one aluminum carrier together with the at least one iron oxide- and phosphate-containing material to form an aluminum-containing phosphate slag melt;
reacting the aluminum-containing phosphate slag melt to elemental gaseous phosphorus, iron and an Al₂O₃-containing slag in a melting vessel;
drawing off elemental, gaseous phosphorus and tapping off the iron and the Al₂O₃-containing slag;
wherein a tin bath is arranged as a cathode body in the melting vessel under the aluminum-containing phosphate slag melt and at least one anode body is arranged to be immersed in the aluminum-containing phosphate slag melt and one of:
a direct current is applied to the cathode body and the at least one anode body; and
a direct current is taken from the cathode body and from the at least one anode body.

24. The method according to claim 23, wherein the at least one iron oxide- and phosphate-containing material is provided as a phosphate slag melt in the melting vessel and the at least one aluminum carrier is added to the phosphate slag melt.

25. The method according to claim 23, wherein a solid material is provided as the iron oxide- and phosphate-containing material and that solid, metallic aluminum is added as the at least one aluminum carrier.

26. The method according to claim 23, wherein an Al₂O₃ carrier is added to the aluminum-containing phosphate slag melt.

27. The method according to claim 23, wherein the basicity, being the weight ratio of CaO/SiO₂, of the aluminum-containing phosphate slag melt is adjusted to a value of 0.65 to 1.4.

28. The method according to claim 23, wherein:
the cathode body is arranged in a first region of the melting vessel in a depression arranged in a partial region of a bottom in the melting vessel;
the at least one anode body is arranged in a second region of the melting vessel different from the first region;
gaseous phosphorus is withdrawn from the first region; and
oxygen is withdrawn from the second region.

29. A device for separating elemental phosphorus from iron oxide-containing and phosphate-containing material, comprising:
a melting vessel formed by a refractory-lined housing;
a phosphate slag melt containing aluminum arranged in the melting vessel;
a gas chamber closed off by the refractory-lined housing above the phosphate slag melt, and a feed device for iron oxide- and phosphate-containing substances and at least one extraction device for gaseous, elemental phosphorus;
a cathode body arranged below the aluminum-containing phosphate slag melt; and
at least one anode body immersed in the aluminum-containing phosphate slag melt;
wherein the aluminum-containing phosphate slag melt is formed by adding at least one aluminum carrier to the at least one iron oxide- and phosphate-containing material and melting the at least one aluminum carrier together with the at least one iron oxide- and phosphate-containing material; and
wherein the device is further configured to:
react the aluminum-containing phosphate slag melt to elemental gaseous phosphorus, iron and an Al₂O₃-containing slag in a melting vessel;
draw off elemental, gaseous phosphorus and tapping off the iron and the Al₂O₃-containing slag; and
one of:
apply a direct current to the cathode body and the at least one anode body; and
take a direct current from the cathode body and from the at least one anode body.

30. The device according to claim 29, wherein the feed device comprises a first tube passing through the housing, in which a conveying device for at least one aluminum carrier is arranged.

31. The device according to claim 29, wherein:
the feed device comprises a first tube passing through the housing, a second tube being arranged in the first tube and forming an annular gap;
one of the first tube and the second tube is configured to feed iron oxide and phosphate-containing substances and the other of the first tube and the second tube is configured to feed aluminum carriers; and
the first tube projects beyond the second tube at its end penetrating the housing.

32. The device according to claim 29, wherein:
the cathode body is arranged in a first region of the melting vessel in a depression arranged in a bottom of the melting vessel;
the at least one anode body is arranged in a second region of the melting vessel laterally spaced from the first region; and
a further extraction device is arranged in the second region.

33. The device according to claim 32, wherein between the first region and the second region a separating wall dividing a gas space into two sections separated from each other is immersed in the aluminum-containing phosphate slag melt.

34. The device according to claim 29, wherein the cathode body is formed by a tin bath.

35. The device according to claim 34, wherein the tin bath is received in a carbon-containing body disposed in the depression.

36. The device according to claim 29, wherein the at least one anode body is formed of graphite, platinum or magnetite spinel.

37. The device according to claim 29, wherein the at least one anode body is formed of a high-alloy steel.

38. The device according to claim 29, wherein the at least one anode body is designed to be coolable.

39. The device according to claim 29, further comprising means for applying a direct current to the cathode body and the anode body.

40. The device according to claim 29, further comprising means for taking a direct current from the cathode body and from the anode body.
